(19) United States
(12) Patent Application Publication
(10) Pub. No.: US 2005/0217403 A1
(43) Pub. Date: Oct. 6, 2005

(54) Selector apparatus of an automatic transmission of vehicle

(76) Inventors: Takayuki Suzuki, Hamana-gun (JP); Shigeaki Oda, Hamana-gun (JP)

Correspondence Address: HARNESS, DICKEY & PIERCE, P.L.C., P.O. BOX 828, BLOOMFIELD HILLS, MI, 48303, US

(21) Appl. No.: 11/090,860

(22) Filed: Mar. 25, 2005

(30) Foreign Application Priority Data
Mar. 25, 2004 (JP) 2004-089723

(51) Int. Cl. B60K 17/04

(52) U.S. Cl. 74/473.12

(57) ABSTRACT

A vehicle automatic transmission selector apparatus which can suppress backlash of teeth of a gear arrangement of a lever bracket and a select-link to improve operability of the selector lever by urging the select-link along its pivotal axis so that the teeth of the select-link are urged onto the teeth of the lever bracket. Brackets (1a) and (1b) are to be secured on a body of a vehicle. A selector lever (2) is pivotally supported on the brackets (1a) and (1b). A lever bracket (3) is arranged at a base end of the selector lever (2) and includes sector gear teeth (3a). A selector-link (4), for actuating a transmission via a wire W interposed between the selector-link (4) and the transmission, includes sector gear teeth (4a) to mate with the sector gear teeth (3a) of the lever bracket (3). The selector-link (4) is rotated by the pivotal motion of the selector lever (2). Tooth surfaces of the teeth (3a) and (4a) of the lever bracket (3) and the select-link (4) are tapered. An urging mechanism (7), (8) and (9) urges the select-link (4) along its pivotal axis so that the teeth (4a) of the select-link (4) are urged on to the teeth (3a) of the lever bracket (3).

### CROSS-REFERENCE TO RELATED APPLICATION

This application claims priority to Japanese Patent Application No. 2004-089723, filed Mar. 25, 2004, which application is herein expressly incorporated by reference.

### FIELD OF THE INVENTION

The present invention relates to a shift selector for vehicle automatic transmissions to carry out the shifting operation of the transmission by transmitting the pivotal motion of the selector lever to a select-link, via a gear arrangement.

### BACKGROUND OF THE INVENTION

In general, a selector apparatus has a selector lever operated by a driver provided on a vehicle with an automatic transmission. The selector lever can be pivotally moved, for example, to a parking position (P), a reverse position (R), a neutral position (N) and a drive position (D). The base end of the selector lever includes a lever bracket which has an aperture for the pivotal shaft of the selector lever and is connected to the automatic transmission via a push-pull wire.

Various structures of selector apparatus have been required to be adapted to the many vehicle interior layout limitations in order to satisfy desires of the users. Accordingly, in Japanese Laid-open Patent Publication No. 315070/1995, a selector apparatus is proposed with a gear arrangement to correspond to the shifting direction of the selector lever and the moving direction of the push-pull wire.

In the selector apparatus of the prior art, a lever bracket is formed with teeth of a sector gear. Also, a select-link is provided with a sector gear having teeth mating with the lever bracket sector gear. The select-link is pivotally mounted on a bracket similarly to the selector lever and is connected to an automatic transmission by an extending push-pull wire. The transmission can be actuated by a driver operating the selector lever, via the sector gear arrangement and the push-pull wire.

However, there is a problem in the prior art vehicle automatic transmission selector apparatus in that a large backlash occurs during meshing of the teeth of the lever bracket and the select-link. Thus, the operability of the selector lever is deteriorated.

### SUMMARY OF THE INVENTION

It is, therefore, an object of the present invention to provide a selector apparatus for a vehicle automatic transmission which can suppress backlash of the gear arrangement of the lever bracket and the select-link. This improves operability of the selector lever by urging the select-link along its pivotal axis so that the teeth of the select-link are urged in to the teeth of the lever bracket.

According to the present invention, a selector apparatus of a vehicle automatic transmission comprises brackets to be secured on a body of vehicle. A selector lever is pivotally supported on the brackets. A lever bracket is arranged at a base end of the selector lever and is formed with sector gear teeth. A selector-link, for actuating a transmission via a wire interposed between the selector-link and the transmission, is formed with sector gear teeth. The gear teeth mate with the sector gear teeth of the lever bracket and are rotated by the pivotal motion of the selector lever. Tooth surfaces of the teeth of the lever bracket and the select-link are tapered. An urging mechanism urges the select-link along its pivotal axis so that the teeth of the select-link are urged on to the teeth of the lever bracket.

It is preferable that a surface of the select-link, against which the urging mechanism abuts, is formed with wavy irregularities. Each irregularity corresponds to one position of the selector lever.

According to the invention, since the urging mechanism usually urges the select-link toward the lever bracket, so that the teeth of the select-link are brought close to the teeth of the lever bracket, it is possible to suppress increase backlash of the teeth of the gear arrangement of the lever bracket and the select-link. Thus, this improves operability of the selector lever. Since the teeth, both of the lever bracket and the select-link are tapered, they can be urged to mesh with each other and thus displace the select-link along its pivotal axis.

According to the invention, since a surface of the select-link against which the urging mechanism abuts is formed with wavy irregularities, each irregularity corresponding to one position of the selector lever, it is possible to provide a vehicle driver with a “shift-click feeling” during the pivotal motion of the selector lever. Accordingly, this enables the elimination of any additional mechanism to generate “shift-click feeling” anywhere in the selector apparatus. Thus, this simplifies the structure of the selector apparatus.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a perspective view of a vehicle automatic transmission selector apparatus of a preferred embodiment of the present invention;

FIG. 2 is a side elevation view of the selector apparatus of FIG. 1, with one of brackets removed;

FIG. 3 is a cross-sectional view taken along a line III-III of FIG. 2;

FIG. 4 is a schematic view showing a positional relation among a lever bracket, a select-link and an urging mechanism of the selector apparatus.

FIG. 5 is an exploded perspective view of the selector apparatus of FIG. 1.

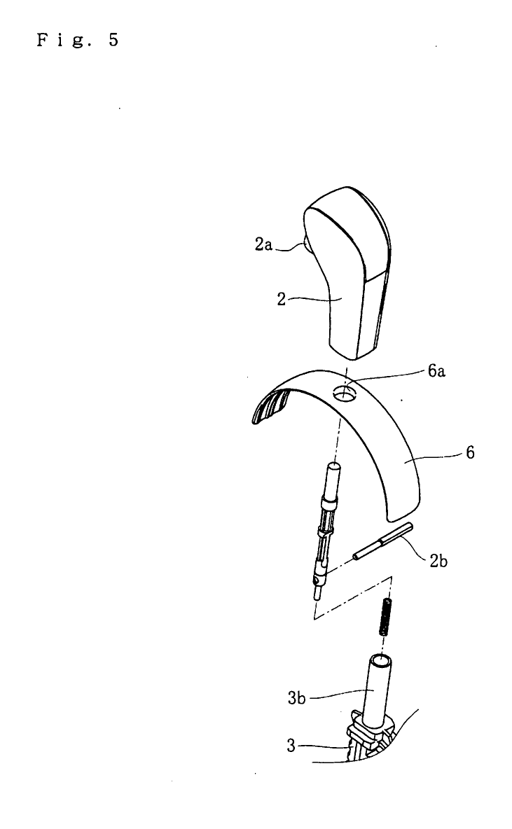

### DETAILED DESCRIPTION OF THE PREFERRED EMBODIMENTS

The following description of the preferred embodiment(s) is merely exemplary in nature and is in no way intended to limit the invention, its application, or uses.

A preferred embodiment of the invention will be described with reference to accompanied drawings.

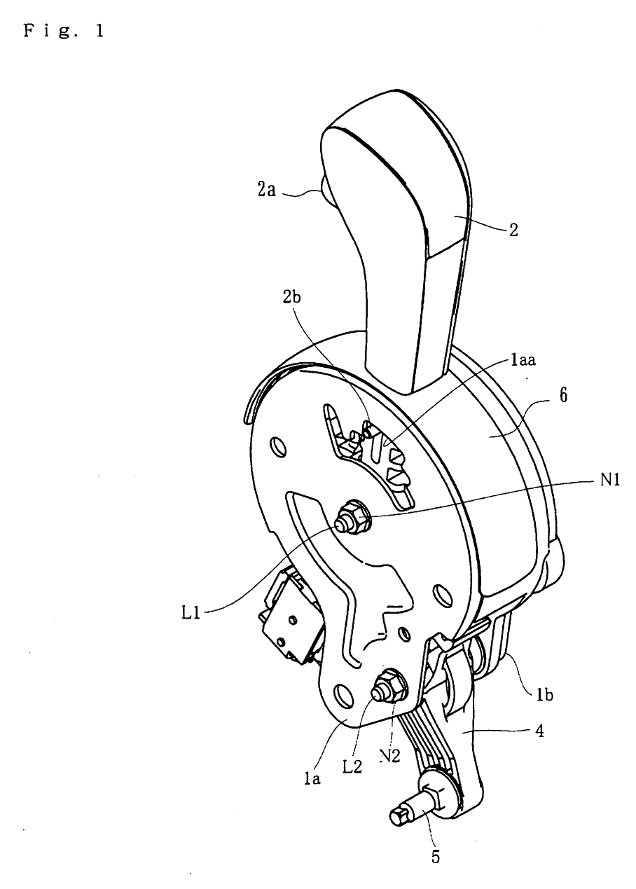

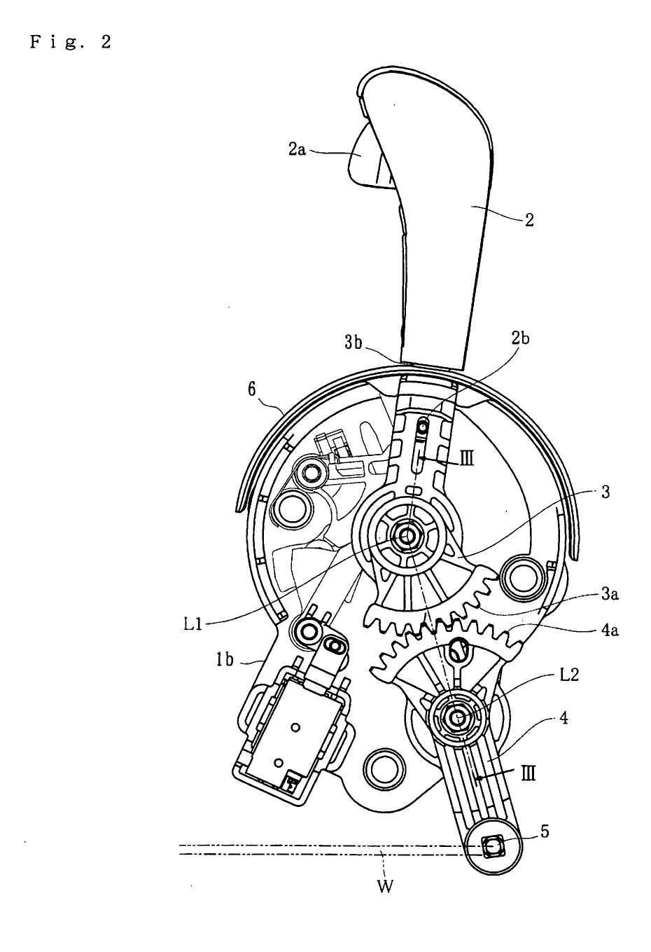

A vehicle selector apparatus automatic transmission of the present invention is a type which can select any driving position of an automatic transmission by transmitting the pivotal motion of a selector lever to a select-link via sector gears. As shown in FIG. 1, the selector apparatus includes brackets 1a and 1b to be secured on a body of a vehicle, a selector lever 2 pivotally supported within the brackets 1a and 1b, a lever bracket 3 (see FIG. 2) mounted on the base end of the selector lever 2, and a select-link 4.

The bracket 1 a is formed from a sheet metal member and includes an erroneous operation preventing window 1aa. The window 1aa has a configuration according to positions of the selector lever 2 as well as apertures to enable passing through of shafts L1 and L2, respectively, of the selector lever 2 and select link 4. The bracket 1a is combined with bracket 1b to form a box structure of the selector apparatus to be mounted on a body of the vehicle.

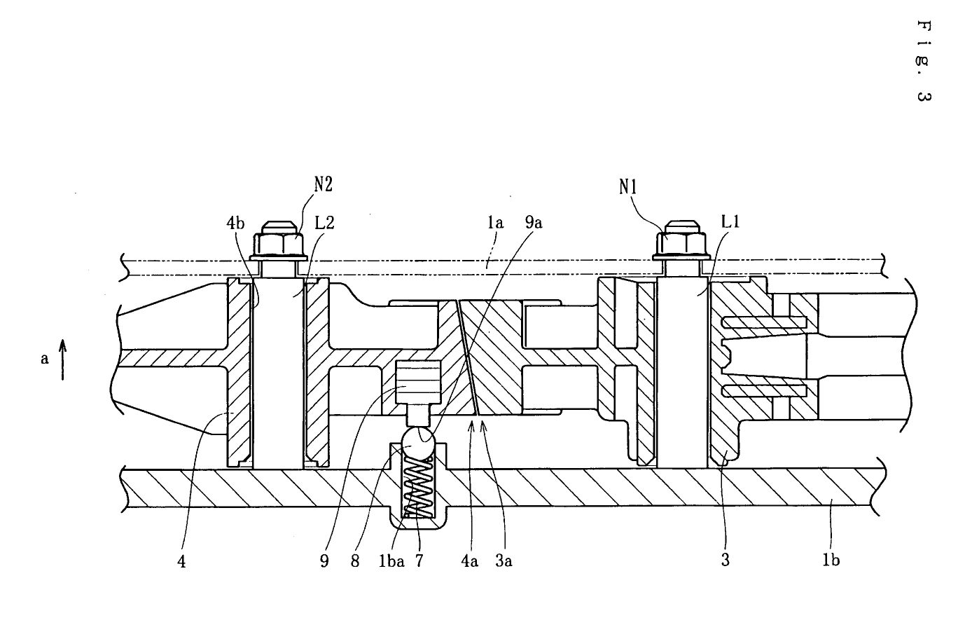

The bracket 1b has a secured shaft L1 and a floating shaft L2 to pivotally support the lever bracket 3 and the select-link 4, respectively. The bracket 1b has an accommodating bore 1ba (see FIG. 3) opened toward the side of the select-link 4. A detent spring 7 and a ball 8, to provide urging, is accommodated in the opening. Each end of the shafts L1 and L2 is formed with a screw thread. Nuts N1 and N2 are fastened onto the threads after the lever bracket 3 and a select-link 4 etc. are assembled onto the bracket 1b via the bracket 1a.

The selector lever 2, pivotally operated by the driver, has a push knob 2a (see FIG. 2) at its top end. The selector lever 2 is connected, at its bottom end, to the lever bracket 3 via a lever pipe (not shown). A rod lock pin (not shown) is arranged within the lever pipe. A lock pin 2b, engaging the erroneous operation preventing window 1aa, is passed through the rod lock pin and the lever bracket 3.

When the selector lever 2 is in the park position (P), the lock pin 2b engages the erroneous operation preventing window 1aa. The pin 2b prevents the selector lever 2 from being shifted toward the reverse position (R). In such a case, if the push knob 2a is pushed down, the rod lock pin 7 is moved downward, the locking of the lock pin 2b is released. Thus the selector lever 2 is allowed to pivot from the park position (P) to the reverse position (R).

Similarly, pivotal motion of the selector lever 2 is prevented unless the push knob 2a is pushed down in cases of shifting the selector lever 2 from the reverse position (R) to the parking position (P), from the neutral position (N) to the reverse position (R), and from the drive position (D) to the second speed position (2).

The lever bracket 3 is arranged at the bottom end (base end) of the selector lever 2. The lever bracket 3 is able to pivot around the shaft L1 together with the selector lever 2. The lever bracket 3 is also formed with teeth 3a of a sector gear at a position lower than the shaft L1.

Similar to the lever bracket 3, the select-link 4 is also pivotable around the shaft L2. Also, at its top end, the select link includes teeth 4a of a sector gear to mate with the teeth 3a of sector gear of the lever bracket 3. The bottom end of the select-link 4 has an end bolt 5 to connect a push-pull wire W (see FIG. 2). The select-link 4 is formed with a through aperture 4b and is pivotably and slidably mounted on the shaft L2. Thus, the select link 4 can slide a slight distance along the shaft L2 as shown by an arrow “a” in FIG. 3.

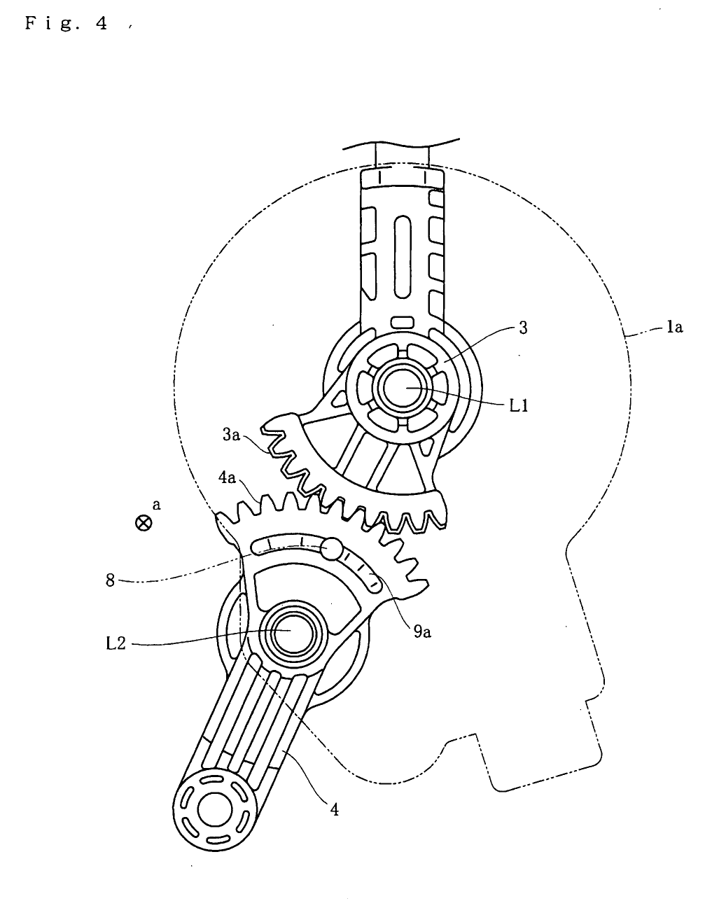

As shown in FIG. 3, the select-link 4 is integrally formed with, by insert method, a slide member 9 of wear resistant material. The slide member 9 has a projected portion projecting from the side of the select-link 4. The projected portion of the slide member 9 has a circular arc configuration viewed from its side as shown in FIG. 4. The surface of the projected portion 9 is formed with wavy irregularities 9a each corresponding to one position of the selector lever 2.

The pivotal motion of the selector lever 2 is transmitted to the select-link 4 via the sector gears. Thus, the automatic transmission is operated via the push-pull wire W. In this case, the direction of the pivotal motion of the selector lever 2 is the same as the moving direction of wire W. A reference numeral 6 in FIGS. 1 and 2 denotes a selector lever cover. The cover 6 moves together with the selector lever 2 which is passed through an aperture 6a formed substantially at the center of the cover 6.

In the selector apparatus of the present invention, the tooth surfaces of the teeth 3a and 4a, respectively, of the lever bracket 3 and the select-link 4 are tapered as shown in FIG. 3. The teeth 3a and 4a of the lever bracket 3 and the select-link 4 form teeth of a so-called “taper-gear”. Thus, the tooth surface of the tooth 3a of the lever bracket 3 forms inclined surfaces in a left-right direction viewed in a sheet of FIG. 3. The tooth surface of the tooth 4a of the select-link 4 forms counter-inclined surfaces in the same direction.

The spring loaded ball 8, urged by the detent spring 7, is adapted to always contact and urge the wavy irregular portion 9a. Since the wavy irregular portion 9a is formed as a circular arc configuration along the pivotal locus of the select-link 4, the ball 8 can always be positioned on the wavy irregular portion 9a.

More particularly, the ball 8 fits into any one recessed portion of the wavy irregularities 9a when the selector lever 2 is positioned at any one of its positions (e.g. parking, reverse or drive position etc.). The ball 8 firmly holds the selector lever 2 at the selected position. During the shift of the selector lever 2 from one position to the other adjacent position, the ball 8 rides over the peak of one wavy irregular portion 9a and then fall down into the valley. This provides a driver of the vehicle with “shift-click feeling” during the operation of the selector lever 2.

Thus, the select-link 4 is always urged, by the ball 8 urged by the detent spring 7, toward a direction shown by an arrow “a” in FIG. 3. Thus, the teeth 4a of the select-link 4 are urged toward the teeth 3a of the lever bracket 3.

Although the select-link 4 is pivotably driven by the selector lever 2, the ball 8 can continue to apply the urging force to the select-link 4 along the wavy irregular portion 9a.

Accordingly, the generation of large backlash between the teeth 3a and 4a of the lever bracket 3 and the select-link 4 is suppressed and the operability of the selector lever 2 is improved. In addition, since a surface of the select-link 4, against which the ball 8 (urging mechanism) abuts, is formed with wavy irregularities 9a, each corresponding to one position of the selector lever 2, it is possible to provide the driver with a “shift-click feeling” during pivotal motion of the selector lever. Accordingly, this enables elimination of any additional mechanism to generate a “shift-click feeling” anywhere in the selector apparatus. Thus, this simplifies the structure of the selector apparatus.

Further, according to the preferred embodiment of the present invention, the select-link 4 is moved by the spring loaded ball 8 along its shaft L2. Thus, the select link 4 is moved toward a direction without giving any influence as to tension to the push-pull wire W. Accordingly, the play of the wire W is not increased and deterioration of the operability of the selector apparatus can be prevented. This is due to the tapered gear arrangement. Thus, the select-link 4 can be moved along its shaft L2, which is a direction not giving any influence as to tension to the push-pull wire W, as can be seen from FIG. 2.

Although the present invention has been described with reference to the preferred embodiment, the present invention is not limited to this embodiment. For example, additional mechanism to generate “shift-click feeling” may be provided anywhere in the selector apparatus, as in the prior art. In this case, the surface with which the spring loaded ball 8 contacts, may be changed to a smooth circular surface. Thus, right side surface of the select-link 4 in FIG. 3 could be circular instead of the wavy irregularities 9.

Furthermore, other urging mechanisms such as an elastic plastic member or rib, leaf spring, or the like could extend from the bore 1ba to the side surface of the select-link 4 and may be used in place of the detent spring 7 and the ball 8. In addition, although it is shown in the preferred embodiment that the urging mechanism is provided on the bracket 1b, it may be possible to provide it on the bracket 1a. In this case, it is necessary to reverse the direction of the taper of teeth 3a and 4a.

The position at which the urging force is applied may be anywhere along the select-link 4. However, it is preferable to set the position near the teeth 4a in order to effectively transmit the urging force to the teeth 3a and 4a. In addition, the present invention can be applied to those having brackets 1a and 1b or selector levers 2 of different configurations. Of course, the present invention can be also applied to a selector apparatus having any type of parking lock mechanism.

The present invention can be applied to any selector apparatus having a different outline configuration or additional function so long as it includes tapered teeth of the lever bracket and the select-link and the urging mechanism applies the urging force to the select-link along its shaft.

The description of the invention is merely exemplary in nature and, thus, variations that do not depart from the gist of the invention are intended to be within the scope of the invention. Such variations are not to be regarded as a departure from the spirit and scope of the invention.

1. A vehicle automatic transmission selector apparatus comprising:
at least one bracket to be secured on a body of a vehicle;
a selector lever pivotally supported on the bracket;
a lever bracket arranged at a base end of the selector lever including sector gear teeth;
a selector-link, for actuating a transmission via a wire interposed between the selector-link and the transmission, including sector gear teeth mating with the sector gear teeth of the lever bracket and rotated by pivotal motion of the selector lever;
tooth surfaces of the teeth of the lever bracket and the select-link are tapered, and an urging mechanism for urging the select-link along its pivotal axis so that the teeth of the select-link are urged on to the teeth of the lever bracket.

2. The vehicle automatic transmission selector apparatus of claim 1, wherein a surface of the select-link, against which the urging mechanism abuts, is formed with wavy irregularities each corresponding to one position of the selector lever.
